(19) United States
(12) Patent Application Publication
(10) Pub. No.: US 2011/0150610 A1
(43) Pub. Date: Jun. 23, 2011

(54) Apparatus for transferring products

(75) Inventor: Guenther Weber, Gross Nemerow (DE)

(73) Assignee: Weber Maschinenbau GmbH Breidenbach, Breidenbach (DE)

(21) Appl. No.: 12/928,737

(22) Filed: Dec. 16, 2010

(30) Foreign Application Priority Data
Dec. 23, 2009 (DE) 10 2009 060 271.2

(51) Int. Cl. B65G 47/90

(52) U.S. Cl. 414/226.01

(57) ABSTRACT

An apparatus for transferring products, e.g. food products, from a pick-up region into a placement region includes a conveying device to convey the products into the pick-up region after one another in a conveying direction and at least one first and one second robot which are arranged spaced apart from one another when viewed in the conveying direction in the environment of the conveying device and which each include a robot base and an end effector movable relative to the robot base for picking up and placing down the products. The spacing between the robot base of the first robot and the robot base of the second robot can be set.

The present invention relates to an apparatus for transferring products from a pick-up region into a placement region, having a conveying device to convey the products into the pick-up region after one another in a conveying direction and having at least one first and one second robot which are arranged spaced apart from one another when viewed in the conveying direction in the environment of the conveying direction and which each include a robot base and an end effector movable relative to the robot base for picking up and placing down the products.

Apparatus of the named kind are used, for example, in the food industry to transfer food products such as meat, sausage or cheese from the conveying device to a further conveying device, to sort them or to introduce them into a packaging. The end effectors are moved relative to their robot base respectively by means of a robot kinematic mechanism for this purpose. The end effectors can be any desired tools by means of which the corresponding products can be picked up, transported and placed down. Systems are known, for example, having two blades which engage beneath the products or having a vacuum suction apparatus.

The robots can be configured in the form of robots having delta kinematics, which are also called parallel robots, as so-called “pick and place” robots and can e.g. transfer products or product portions from the starting conveyor of a cutting apparatus into a packaging machine.

The provision of two or more robots spaced apart in the conveying direction and working in parallel increases the total speed of the transfer and thus the number of portions or products to be handled per time unit. On switch-overs with respect to the kind of product, the portion form and/or the conveying speed, maladjustments of the individual operating parameters can, however, occur so that the performance capability of the transfer apparatus is not ideally utilized under certain circumstances.

It is therefore an object of the invention to improve the efficiency of a product transfer apparatus of the generic type with a justifiable construction effort.

The object is satisfied by an apparatus having the features of claim 1.

In accordance with the invention, the spacing between the robot base of the first robot and the robot base of the second robot is adjustable. The invention is based on the recognition that an adjustment of the spacing of the robots to one another to the operating parameters of the respective application is necessary to achieve the maximum possible performance capability of the transfer apparatus. The apparatus in accordance with the invention makes it possible to set the distance between the robots to a value at which a maximum transfer performance results. Switch-overs with respect to the products or product portions to be transferred and/or with respect to the conveying speed can thus be carried out without having to fear unnecessarily high losses in the performance of the transfer apparatus.

The spacing of the robot base of the first robot and of the robot base of the second robot can be adjustable when viewed in the conveying direction and/or when viewed transversely to the conveying direction. The spacing of the robots in the conveying direction can thus be adapted to the spacing of the products or product portions to be transferred, when viewed in the conveying direction. A settability of the spacing of the robots transversely to the conveying direction makes possible a better adaptation of the working region of robots which are arranged laterally offset with respect to one another and which can be used e.g. in conveying products in a plurality of rows parallel to the conveying direction.

In accordance with an embodiment, a control device is provided to set the spacing between the robot base of the first robot and the robot base of the second robot in dependence on the spacing between products conveyed by the conveying device. In this respect, in dependence on the application, the spacing between two products conveyed after one another can be used as a reference value or the spacing between a conveyed product and any desired product following later. On a change of the product spacing, the control device can therefore provide that the robot spacing is also automatically changed accordingly.

A control device can in particular be provided to set the relationship of the spacing between conveyed products to the spacing between the robot base of the first robot and the robot base of the second robot to a preset ideal value. This is based on the recognition that the relationship of product spacing to robot spacing has a significant influence on the transfer performance and a maximum transfer performance is achieved at a specific value. The control device thus therefore ensures that no transfer performance is “wasted”.

In accordance with a further embodiment, the apparatus is disposed after a product processing apparatus, e.g. a cutting apparatus, and a control device sets the spacing between the robot base of the first robot and the robot base of the second robot in dependence on operating parameters of the product processing apparatus and/or of the conveying device. The control device can communicate for this purpose in a suitable manner with a control device of the product processing apparatus and/or of the conveying device. It is thus, for example, possible to report the respective relevant parameter values with respect to the processing or conveying speed from which the product spacing results to the control device of the robots before the start of the transfer operation, whereupon the control device effects the setting of the corresponding ideal robot spacing.

In accordance with a further embodiment, a control device is provided to set the spacing between the robot base of the first robot and the robot base of the second robot to a whole-number multiple of the spacing between products conveyed following after one another. It has been shown that a whole-number relationship between the product spacing and the robot spacing is particularly advantageous with respect to the transfer performance.

A further embodiment of the invention provides that the robot base of the first robot and the robot base of the second robot are each attached to a stationary support frame of the apparatus in a manner adjustable by a motor. Due to the comparatively small construction effort required for this purpose, a corresponding transfer apparatus can be provided relatively inexpensively or an existing system can also be easily retrofitted at a later date.

The connection line between the center of the robot base of the first robot and the center of the robot base of the second robot can extend parallel to the conveying direction. The geometrical center or the center of mass can be considered the center of the robot base. In this embodiment, the robots are therefore arranged after one another along the conveying path. Alternatively, an arrangement is also conceivable with robot bases mutually laterally offset, as was mentioned above.

In accordance with a further embodiment, more than two robots can be provided and the spacings between all adjacent robot bases can be settable. A control device or a positive coupling is preferably provided to set the spacings between the robot bases of all robots to the value of the spacing between the robot base of the first robot and the robot base of the second robot. The same ideal spacing can hereby be set between all robots and a maximum transfer performance can be achieved. An individual adaptation of the individual spacings is neither sensible nor necessary in the normal case since, when the operating conditions remain the same, the product spacings also remain the same.

In accordance with a further embodiment, a packaging apparatus is arranged in the placement region and the transferred products or portions are placed directly into it. Alternatively, the product or the portion can, however, also be transferred to a further conveying device.

The robots are preferably robots working according to the delta principle. Such delta robots or parallel robots only require small moved masses and are particularly suitable for “pick and place” work.

Further advantageous embodiments of the invention can be seen from the dependent claims, from the description and from the drawing.

The invention will be described in the following by way of example with reference to the enclosed drawing.

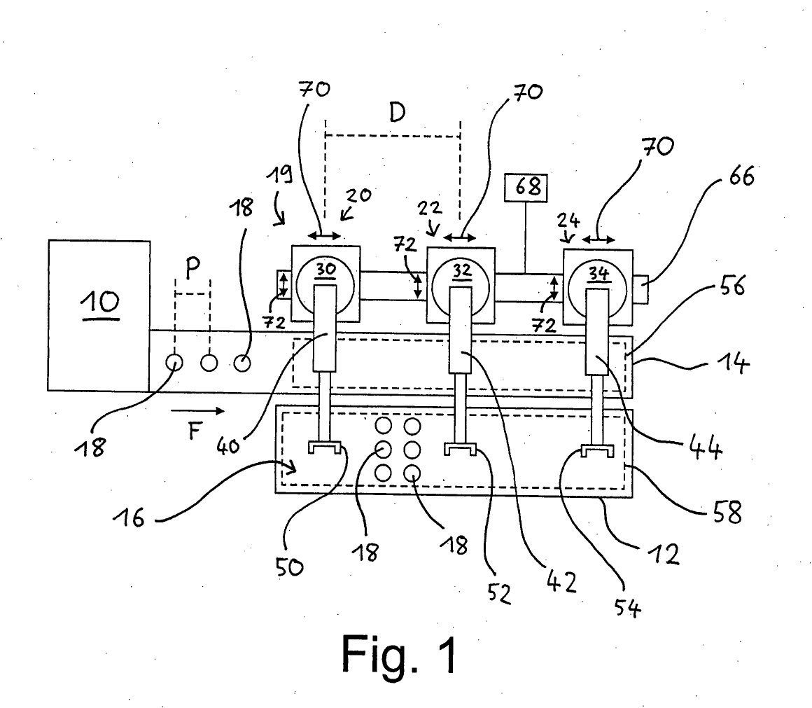

FIG. 1 shows a simplified plan view of an apparatus in accordance with the invention for the processing of food products which includes an arrangement of three robots for transferring the food products;

A cutting line with a high-performance slicer 10 for slicing food products and having a packaging machine 12 arranged after the slicer 10 for the preparation of portion packages ready for sale is shown in FIG. 1. The slicer 10 is made to cut off slices from a product loaf such as a loaf of sausage, meat or cheese at high speed. The cut-off product slices fall onto a belt conveyor 14 and are transported, optionally in the form of product portions 18 which are composed of a plurality of slices, by said belt conveyor along a conveying direction F.

To transfer the product portions 18 from the belt conveyor 14 to a product tray 16 of the packaging machine 12 located in a placement region 58, a transfer apparatus 19 is provided having an arrangement of a first robot 20, a second robot 22 and a third robot 24. In the example shown, the robots 20, 22, 24 are “pick and place” robots with delta kinematics.

The first robot 20 includes a base 30, a kinematic mechanism 40 movably attached thereto as well as an end effector 50 coupled to the kinematic mechanism 40. The second robot 22 and the third robot 24 are made analog to the first robot 20 and accordingly each include a base 32, 34, a kinematic mechanism 42, 44 as well as an end effector 52, 54. In the following, for reasons of simplicity, the base 30 of the first robot 20 is called a “first robot base”, the base 32 of the second robot 22 is called a “second robot base! and the base 34 of the third robot 24 is called a “third robot base”.

The product portions 18 are transported by the belt conveyor 14 into a pick-up region 56 of the robots 20, 22, 24, are picked up by the end effectors 50, 52, 54 of the robots 20, 22, 24 and are transferred into the packaging machine 12. In this respect, depending on the application, sorting procedures or the positioning of the product portions 18 in the packaging machine 12 to a format set can be carried out as additional tasks.

As can be seen from FIG. 1, the first, second and third robot bases 30, 32, 34 are each attached to a stationary support frame 66 of the transfer apparatus 19 in a manner adjustable by a motor. The adjustment of the robot bases 30, 32, 34 is effected by a control device 68 which can be integrated into a control device for controlling the movement of the robot kinematic mechanisms 40, 42, 44.

The spacing between the first robot base 30 and the second robot base 32 or the spacing between the second robot base 32 and the third robot base 34, when viewed in the conveying direction F, can be varied by a correspondingly controlled motor-powered movement of the robot bases 30, 32, 34 relative to the support frame 66, which is shown by double arrows 70 in the FIGURE. The control device 68 in the embodiment shown always sets the spacings between the respective adjacent robot bases 30, 32, 34 to a common value D which is also called a “robot spacing” in the following.

The robot spacing D is in this respect set in dependence on the spacing between product portions 18 following one another and conveyed by the first belt conveyor 14—also called a product spacing P in the following. The setting in this respect takes place such that the relationship of the robot spacing D to the product spacing P corresponds to a presettable ideal value which results in a maximum performance of the transfer apparatus 19.

Since the product spacing P depends both on the cutting speed of the slicer 10 and on the conveying speed of the belt conveyor 14, these parameters are transferred to the control device 68 so that it determines the product spacing P from the received data. It is generally also possible to determine the product spacing P not with reference to the named parameters, but rather to detect it by means of suitable sensors.

The control device 68 determines an ideal robot spacing D from the product spacing P with knowledge of the ideal spacing relationship. The robot bases 30, 32, 34 are then moved into the respective desired position for setting the ideal robot spacing D.

The relationship between the set robot spacing D and the product spacing P is preferably a whole number. Purely by way of example, the robot spacing D can amount to 800 mm and the product spacing P to 200 mm.

In addition, in the transfer apparatus 19, the spacing between the first robot base 30 and the second robot base 32 as well as the spacing between the second robot base 32 and the third robot base 34 are set transversely to the conveying direction F, which is shown in FIG. 1 by double arrows 72.

The total number of robots 20, 22, 24 is based on the respective demanded transfer performance. Three robots are shown here only by way of example.

Since the relationship of the robot spacing D to the product spacing P is also kept at the optimum value with respect to the transfer performance, a high efficiency of the transfer apparatus is ensured. The transfer potential is fully exploited without the operator of the plant having to look after it separately.

### REFERENCE NUMERAL LIST

10 slicer
12 packaging machine
14 belt conveyor
16 product support
18 product portion
19 transfer apparatus
20 first robot
22 second robot
24 third robot
30 first base
32 second base
34 third base
40 first kinematic mechanism
42 second kinematic mechanism
44 third kinematic mechanism
50 first end effector
52 second end effector
54 third end effector
56 pick-up region
58 placement region
66 support frame
68 control device
70 adjustment in the conveying direction
72 adjustment transversely to the conveying direction
F conveying direction
D robot spacing
P product spacing

1. An apparatus (19) for transferring products (18), e.g. food products, from a pick-up region (56) into a placement region (58), comprising a conveying device (14) to convey the products (18) into the pick-up region (56) after one another in a conveying direction (F); and at least one first and one second robot (20, 22) which are arranged spaced apart from one another when viewed in the conveying direction (F) in the environment of the conveying device (14) and which each include a robot base (30, 32) and an end effector (50, 52) movable relative to the robot base (30, 32) for picking up and placing down the products (18),
characterized in that
the spacing (D) between the robot base (30) of the first robot (20) and the robot base (32) of the second robot (22) can be set.

2. An apparatus in accordance with claim 1,
characterized in that
the spacing (D) of the robot base (30) of the first robot (20) and of the robot base (32) of the second robot (22) can be set, when viewed in the conveying direction (F) and/or when viewed transversely to the conveying direction (F).

3. An apparatus in accordance with claim 1,
characterized in that
a control device (68) is provided to set the spacing (D) between the robot base (30) of the first robot (20) and the robot base (32) of the second robot (22) in dependence on the spacing (P) between products (18) conveyed by the conveying device (14).

4. An apparatus in accordance with claim 1,
characterized in that
a control device (68) is provided to set the relationship of the spacing (P) between conveyed products (18) to the spacing (D) between the robot base (30) of the first robot (20) and the robot base (32) of the second robot (22) to a presettable ideal value.

5. An apparatus in accordance with acclaim 1,
characterized in that
the apparatus (19) is disposed after a product processing apparatus (10), e.g. a cutting apparatus, and a control device (68) automatically sets the spacing (D) between the robot base (30) of the first robot (20) and the robot base (32) of the second robot (22) in dependence on operating parameters of the product processing apparatus (10) and/or of the conveying device (14).

6. An apparatus in accordance with claim 1,
characterized in that
a control device (68) is provided to set the spacing (D) between the robot base (30) of the first robot (20) and the robot base (32) of the second robot (22) to a whole-number multiple of the spacing (P) between conveyed products (18) following one another.

7. An apparatus in accordance with claim 1,
characterized in that
the robot base (30) of the first robot (20) and the robot base (32) of the second robot (22) are each attached to a stationary support frame (66) of the apparatus (19) in a manner adjustable by a motor.

8. An apparatus in accordance with claim 1,
characterized in that
the connection line between the center of the robot base (30) of the first robot (20) and the center of the robot base (32) of the second robot (22) extends parallel to the conveying direction (F).

9. An apparatus in accordance with claim 1,
characterized in that
more than two robots (20, 22, 24) are provided and the spacings (D) between the robot bases (30, 32, 34) of all robots (20, 22, 24) can be set.

10. An apparatus in accordance with claim 9,
characterized in that
a control device (68) or a positive coupling is provided to set the spacings (D) between all the robot bases (30, 32, 34) to the value of the spacing between the robot base (30) of the first robot (20) and the robot base (32) of the second robot (22).

11. An apparatus in accordance with claim 1,
characterized in that
a packaging apparatus (12) is arranged in the placement region (58).

12. An apparatus in accordance with claim 1,
characterized in that
the robots (20, 22, 24) are robots working in accordance with the delta principle.
